(19) United States
(12) Patent Application Publication
(10) Pub. No.: US 2014/0052536 A1
(43) Pub. Date: Feb. 20, 2014

(54) SYSTEM AND METHOD FOR UNSOLICITED CONTENT DISPLAY DURING LATENCY ON MOBILE DEVICES

(71) Applicants: Mark McAndrew, Dursley (GB); Paul McAndrew, Stockport (GB)

(72) Inventors: Mark McAndrew, Dursley (GB); Paul McAndrew, Stockport (GB)

(21) Appl. No.: 13/964,303

(22) Filed: Aug. 12, 2013

Related U.S. Application Data
(60) Provisional application No. 61/682,565, filed on Aug. 13, 2012.

(51) Int. Cl. G06Q 30/02

(52) U.S. Cl. CPC G06Q 30/0267; G06Q 30/0261
USPC 705/14.58; 705/14.64

(57) ABSTRACT

A system and methods are disclosed whereby a mobile device is provided by one or more servers with unsolicited content. The mobile device stores the unsolicited material e.g. an ordered set of advertisements. A latency delay detector detects an imminent delay for the mobile device that then displays unsolicited items during the latency delay. Display is in screen whitespace and/or wallpaper areas, one item at a time in sequence, each for a predetermined period. Displayed items are purged after display and a user elects whether of not to receive unsolicited material.

### CROSS-REFERENCE TO RELATED APPLICATION

This application claims the benefit of U.S. Provisional Application No. 61/682,565, filed Aug. 13, 2012, the entire disclosure of which is incorporated herein by reference.

### FIELD OF THE INVENTION

The present invention relates generally to the field of mobile devices and, in particular, to displaying unsolicited content on mobile devices, and associated systems and methods.

### BACKGROUND OF THE INVENTION

Mobile devices capable of wireless data communication, including communication to the Internet, are in widespread use around the world. Such devices include cell phones, smart phones, tablet personal computers (PCs), notebook computers, and personal digital assistants (PDAs). Typically, mobile devices support communication applications such as web browsers and email clients. Because of their growing popularity and geographic reach, mobile devices represent a sought-after medium for unsolicited content providers such as advertisers. However, the design of these mobile devices and of the service delivery systems that support them come with trade-offs in terms of device display size, on-board computing resources, and data transmission bandwidth.

One key to portability of a mobile device is small size. Because of this design limitation, a mobile device typically presents limited screen area, or “real estate,” for the display of a user interface. One approach to conforming to the display requirements for such a device is to reduce the area of displayed objects (e.g., graphical icons, application windows). However, shrinking a display object fails when the user of a mobile device can no longer visually discern information from that object. Furthermore, devices that employ a touch screen (“swiping”) interface rather than a keyboard or other off-screen pointing device must size and organize display objects to support physical manipulation via the display. This interface requirement further limits the practicality of shrinking display objects, putting even more of a premium on available screen real estate. Given the current state of the mobile device design, small screen sizes mean that every display object competes for limited screen real estate with other content. Because cluttering of a user interface on a mobile device can compromise the user experience, unsolicited content such as advertising is not typically of high priority for display.

The small overall size of a mobile device can also drive design decisions to limit the device's on-board computing resources, such as memory capacity, processing speed, and storage space. Consequently, too many applications executing simultaneously and competing for limited computing resources can perceptibly degrade the performance of a mobile device. Also, data transmission bandwidth may be limited by the design of a particular mobile device and/or by the network coverage provided by a wireless carrier (for example, service by a 3G versus 4G data network). Therefore, the user experience with mobile applications that require wireless data transmission can be degraded by network bottlenecks that manifest as slow response times. Both of these performance pressures work against the introduction of processes to deliver unsolicited content to mobile devices. Nonetheless, various approaches to handling delivery of unsolicited content to mobile devices exist in the state of the practice.

U.S. Pat. No. 6,985,933 to Singhal et al discloses use of a wireless device to pre-fetch contents from web sites identified as most likely to be requested by a user of the device in a given environment, thus making the content available for rapid retrieval at the device. Pre-fetching is scheduled during times when data transmission bandwidth to and from the device is not in use in order to speed responsiveness of the device. However, the disclosed solution does not address display of pre-fetched content unless requested by the user of the device.

U.S. Pat. No. 6,363,419 to Martin et al. discloses a system for displaying content on a wireless computing device during periods when processing on the device itself is otherwise idle. Content is displayed via a browser program, and may include advertising from a service provider or from third parties. However, the reference does not disclose display of unsolicited content during periods when the mobile device is experiencing latency in an actively processing (not idle) application.

U.S. Published Patent Application No. 2011/828288 by Kharebov et al. discloses playing an advertisement to a user of the mobile device while the user is waiting for content to download. Advertisement content may be pre-fetched in anticipation of a future delay related to accessing a network resource. However, the Kharebov reference initiates an advertisement process as a new display object that competes for screen real estate with existing objects.

There exists a need to deliver and display unsolicited content on mobile devices within the limits of existing screen real estate, and without compromising the experience of the mobile device user. This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the foregoing in mind, embodiments of the present invention provide a system and method for using existing mobile device display real estate to display unsolicited content, such as advertisements. To minimize any obtrusion of the user experience, unsolicited content may be pre-loaded for display in temporarily unused portions of a mobile device display during periods of latency in active mobile applications.

### BRIEF DESCRIPTION OF THE DRAWINGS

FIG. 1 is a block diagram illustrating a system for delivery of unsolicited content to a mobile device according to an embodiment of the present invention.

FIG. 2 is a block diagram illustrating a scheduling and display component of a system for delivery of unsolicited content on a mobile device according to an embodiment of the present invention.

FIG. 3 is a flowchart illustrating a method aspect of an embodiment of the present invention for delivery of unsolicited content on a mobile device.

FIG. 4 is a flowchart illustrating a method aspect of an embodiment of the present invention for delivery of unsolicited content on a mobile device.

FIG. 5 is a diagram illustrating a screen shot of a system interface of the system illustrated in FIG. 1.

FIG. 6 is a flowchart illustrating a method aspect of an embodiment of the present invention for delivery of unsolicited content on a mobile device.

FIGS. 7A, 7B, 7C, and 7D are diagrams illustrating a changing state of a mobile device user interface during display of unsolicited content as implemented by the system illustrated in FIG. 1.

FIG. 8 is a block diagram illustrating a diagrammatic representation of a machine in the example form of a computer system according to an embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art will realize that the following embodiments of the present invention are only illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Example methods and systems for unsolicited content display during latency on mobile devices are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation.

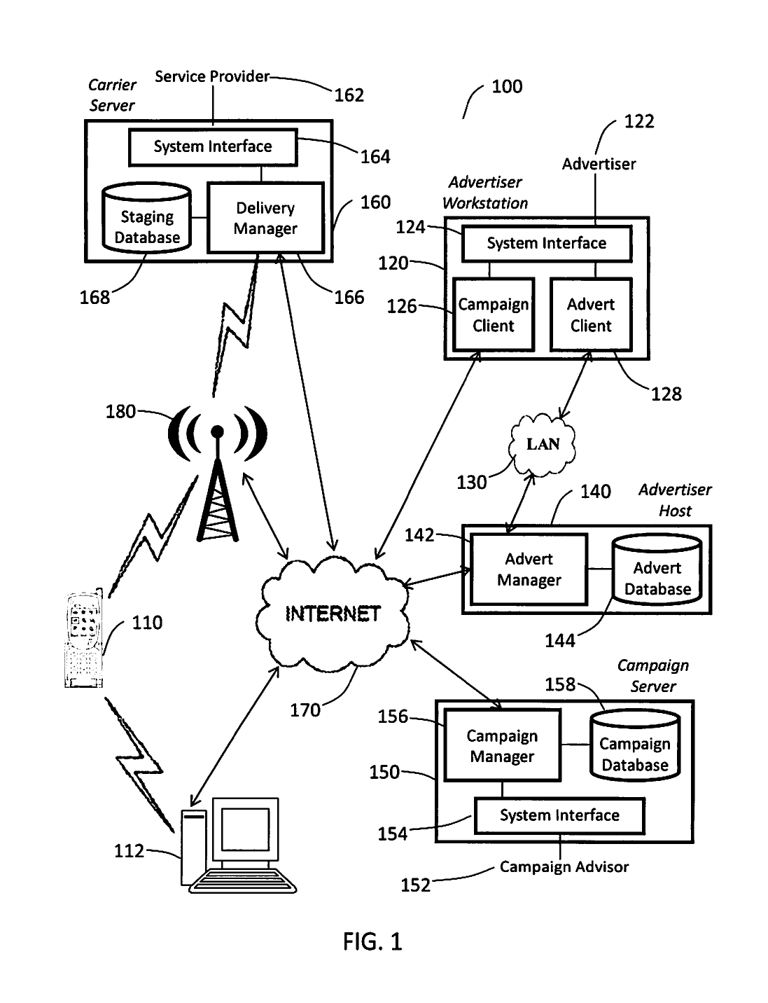

Referring now to FIGS. 1-8, a system 100 for displaying unsolicited content during latency on mobile devices 110 according to an embodiment of the present invention is now described in greater detail. Throughout this disclosure, the present invention may be referred to as an unsolicited content display system 100, a UCD system 100, a computer program product, a computer program, a product, a system, a tool, and a method. Those skilled in the art will appreciate that this terminology does not affect the scope of the invention as outlined herein.

In the following disclosure, the present invention may be referred to as relating to unsolicited content, adverts, advertisements, marketing campaigns, and ads. Those skilled in the art will appreciate that this terminology is only illustrative and does not affect the scope of the invention. For instance, the present invention may just as easily relate to electronic coupons, political messages, public service announcements, or informational broadcasts.

Referring initially to FIG. 1, an unsolicited content display (UCD) system 100 according to an embodiment of the present invention is now described in greater detail. The UCD system 100 may include a carrier server 160 that may be adapted to be used in connection with a mobile network 180 to position the carrier server in communication with a mobile device 110. The mobile device 110 may be a computerized device, such as a cell phone, smart phone, notebook computer, a tablet personal computer (PC), a personal digital assistant (PDA). The carrier server 160 may be in communication with the mobile device 110 so that digital information may be transmitted from the carrier server to the mobile device.

The carrier server 160 and the mobile device 110 may be connected to the mobile network 180 via a server, a network interface device, or any other device capable of making such a connection. Alternatively, or in addition, the mobile device 110 may be configured to be connected with a network 170, such as the Internet, via a hotspot 112, for example, that may employ a router connected to a link to a network. For example, and without limitation, the mobile device 110 may be connected to the Internet by a network interface device implemented as a wireless fidelity (WiFi) workstation 112. The network interface device 112 may be any type of network interface device, including, without limitation, an Ethernet card and a wireless communication device such as an 802.11/WiFi network interface or a Wireless LAN device. The mobile network 180 may be any type of cellular network device, including GSM, GPRS, CDMA, EV-DO, EDGE, 3G, DECT, OFDMA, WIMAX, and LTE communication devices. These and other communication standards permitting connection to a network 170, such as the Internet, are included within the invention. Moreover, other communication standards connecting the mobile device 110 with an intermediary device that is connected to the Internet, such as USB, FireWire, Thunderbolt, and any other digital communication standard is included within the invention.

The carrier server 160 may include a staging database 168. The staging database 168 may include digital information in the form of unsolicited content, such as advertisements, pictures, figures, text, videos, audio recordings or any other digital content. A service provider 162 may manage or otherwise manipulate the unsolicited content in the staging database 168 by interacting with the delivery manager 166 via a system interface 164. Upon recognition by the delivery manager 166 that a mobile device 110 is ready to receive unsolicited content, the delivery manager 166 may transmit unsolicited content included by the staging database 168 to the mobile device 110 via the mobile network 180 or via the network 170 through network interface device 112. Due to increased costs and data limits associated with transmission over some network connections, for instance, cellular network connections, transmission of unsolicited content may be limited to transmission across non-cellular networks 170.

In one embodiment of the present invention, unsolicited content may be transmitted from an advertiser host 140 to the carrier server 160 to be staged in the staging database 168 for subsequent delivery to a mobile device 110. The advertiser host 140 may include an advert manager 142 having an associated advert database 144 that includes unsolicited content, such as advertisements, that is specific to the business entity that controls the advertiser host 140. From an advertiser workstation 120, an advertiser 122 may manage or otherwise manipulate the unsolicited content in the advert database 144 by using a system interface 124 to interact with the advert manager 140 through an advert client 128. For example, and without limitation, a local area network (LAN) 130 may support communication between the advert client 128 and the advert manager 142.

The advert manager 142 may be configured to be in communication with the carrier server 160, or with the mobile device 110, or both. The advert manager 142 may be in communication the mobile device 110 and/or the carrier server 160 across a network 170 via a network interface substantially as described above for the carrier server 160 and the mobile device 110. Moreover, the advert manager 142 may optionally be configured to function as an intermediate device between the mobile device 110 and the carrier server 160. In such a case, any request for unsolicited content from the mobile device 110 may be received by the advert manager 142 and re-transmitted to the carrier server 160.

In another embodiment of the present invention, unsolicited content may be transmitted from a campaign server 150 to the carrier server 160 to be staged in a staging database 168 for subsequent delivery to a mobile device 110. The campaign server 150 may include a campaign manager 156 having an associated campaign database 158 that includes unsolicited content, such as advertisements, received from an advertising customer and managed by a campaign advisor 152. For example, and without limitation, an advertiser 122 may use a system interface 124 to access a campaign client 126 on an advertiser workstation 120 to create adverts for inclusion in an advertising campaign. A network 170, such as the Internet, may support communication between the campaign client 126 and the campaign manager 156.

The campaign manager 156 may be configured to be in communication with the carrier server 160, or with the mobile device 110, or both via a network 170 that may employ a network interface substantially as described above for the carrier server 160 and the mobile device 110. Moreover, the campaign manager 156 may optionally be configured to function as an intermediate device between the mobile device 110 and the carrier server 160, wherein any request for unsolicited content from the mobile device 110 may be received by the campaign manager 156 and re-transmitted to the carrier server 160.

The delivery, scheduling, and display functions of the unsolicited content display (UCD) system 100 will be described individually in greater detail below.

### Delivery

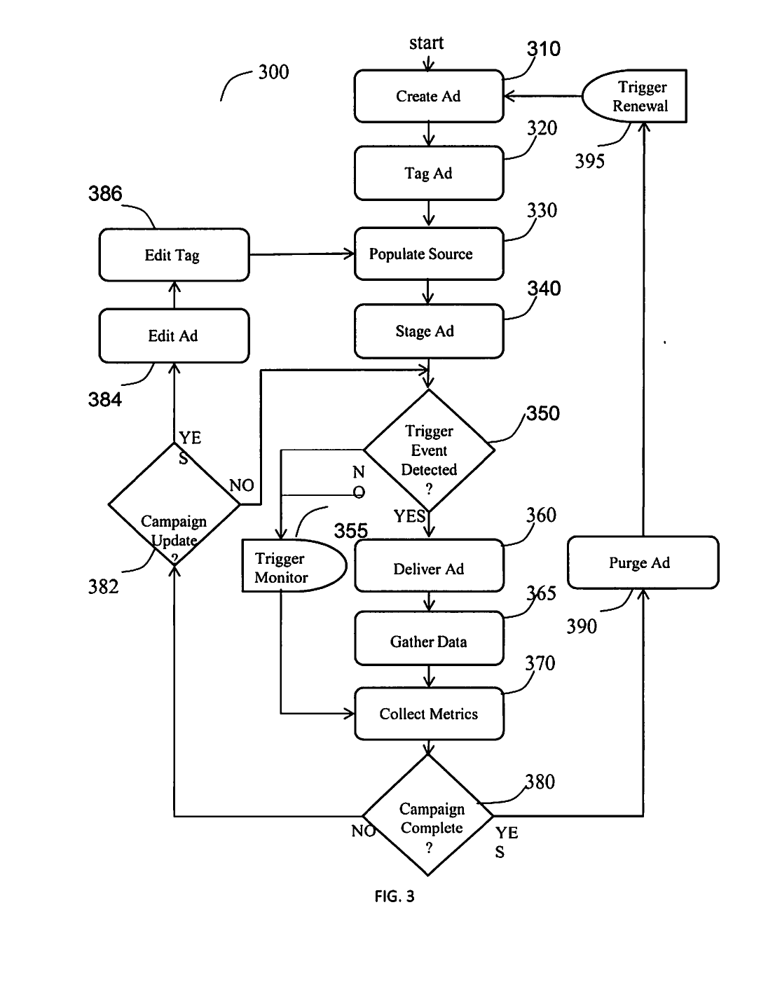

Referring now to flowchart 300 of FIG. 3, the operation of the delivery function of the UCD system 100 will be discussed in greater detail. More specifically, the relationship between the carrier server 160, the mobile device 110, and the operational steps of unsolicited content delivery will now be discussed. The following illustrative embodiment is included to provide clarity for one operational method that may be included within the scope of the present invention. A person of skill in the art will appreciate additional databases and operations that may be included within the UCD system 100 of the present invention, which are intended to be included herein and without limitation.

From the start, the operation may begin at Block 310, where an advertiser 122 may choose to create unsolicited content, for example, in the form of an advertisement, designed for display on a mobile device 110. More specifically, the unsolicited content included in the staging database 168 may be formatted, proportioned, or otherwise configured to be displayed on an electronic visual display of the mobile device 110 that is of a size typically found on a mobile computerized device such as a smart phone, tablet personal computer (PC), personal digital assistant (PDA), or notebook computer. Desirously, the unsolicited content may be created so as to not require re-formatting to conform to the display requirements and limitations of a mobile device 110. The advertiser 122 may tag the unsolicited content (Block 320) with meta-data such as, and without limitation, product type, creation date, originator, digital file size, target market, and vendor identifier.

At Block 330, the advertiser 122 may choose to populate one or more source databases with newly created unsolicited content. For example, and without limitation, the source databases may include an advert database 144 and/or a campaign database 158. The unsolicited content may be staged (Block 340) for download from the staging database 168 on the carrier server 160.

Upon the occurrence of a triggering event (Block 350), such as a request originating from a mobile device 112, the delivery manager 166 may deliver unsolicited content (Block 360) by transmitting the unsolicited content to the mobile device 110 across an available network 112, 180. The unsolicited content delivered to the mobile device 110 may include, for example and without limitation, one or more advertisements. A triggering event may be recognition of readiness of a mobile device 110 to receive unsolicited content, or any action taken by the mobile device 110, the user of the mobile device 110, or delivery manager 166 that would indicate the transmission of unsolicited content to the mobile device 110. For example, and not by limitation, the triggering event may be the client device turning on, web browsing software opening, an application or program opening, a web page being visited, a download initiating, connection to a network 112, 180 being made, or unsolicited content being removed from a mobile device 110. When one or more such triggering events occur, the mobile device 110 may accept transmittal of unsolicited content from the staging database 168 through the delivery manager 166. Alternatively, the triggering event may originate at the client server 160. For example, and without limitation, the triggering event may be the addition of new unsolicited content to the staging database 168, removal of unsolicited content from the staging database 168, or modification of unsolicited content on the staging database 168. When one of these staging database 168 triggering events occur, the delivery manager 166 may transmit a signal to the mobile device 110 indicating the availability of unsolicited content for delivery to the mobile device 110. In response, the mobile device 110 may allow transmittal of the unsolicited content (Block 360) from the delivery manager 166.

The delivery manager 166 may gather data (Block 365) related to a mobile device 110 to which a delivery (Block 360) is accomplished. For example, and without limitation, when a delivery manager 166 detects a triggering event (Block 350) such as a request for unsolicited content from a mobile device 110, the delivery manager 166 may create a user account associated with the mobile device 110 which may comprise information related to the mobile device 110 including, without limitation, device specifications such as electronic visual display dimensions and resolution, processing power, graphical processing power, network connection devices, estimated network connection bandwidth, storage space, memory, and operating system(s) and software installed on the mobile device 110. The user account may then be stored (Block 365) on the staging database 168, such that each time the mobile device 110 requests unsolicited content, this information may not need to be re-collected by the delivery manager 166. The data gathered at Block 365 may include further information, including, but not limited to, demographic information related to a user of the mobile device 110, browsing history of the mobile device, and current and historic geographic location of the mobile device. The delivery manager 166 may periodically check the information and determine whether the information associated with a user account is accurate. If not, the information stored in the user account may be updated.

Continuing with the preceding example, when the delivery manager 166 detects a triggering event (Block 350) such as a request for download of unsolicited content from a mobile device 110 for which a user account exists, or after a creation of a user account in response to the request, the delivery manager 166 may select unsolicited content from the staging database 168 based upon the information contained in the request from the mobile device 110. For example, and without limitation, if the request includes an indication that the mobile device 110 has visited the website associated with a specific vendor, the delivery manager 166 may select content associated with the specific vendor from the staging database 168 and deliver unsolicited content. As another example, if the request includes information indicating the mobile device 110 is currently, or historically has been, in the vicinity of a business location of a specific vendor, the delivery manager 166 may select and deliver unsolicited content associated with the specific vendor. In yet another example, if the request includes information indicating the dimensions and/or resolution of an electronic visual display of the mobile device 110, the delivery manager 166 may select and deliver unsolicited content that is formatted to be displayed on displays with the same or similar dimensions and/or resolutions as indicated in the request.

At Block 370, the delivery manager 166 may collect metrics related to unsolicited content delivery activity per Block 360 (or, alternatively, to the absence of delivery activity per Block 355). At Block 380, the delivery manager 166 may analyze metrics collected at Block 370 to ascertain if a campaign to deliver unsolicited content (e.g., an advertising campaign) is complete (Block 380). For example, and without limitation, the delivery manager 166 may determine if campaign objectives have been met by comparing actual delivery metrics to the campaign duration, the deliveries count, and/or sales target established during planning of the campaign. A campaign may be declared complete based on success or on failure to achieve campaign objectives. This analysis by the delivery manager 166 may have a human in the loop, for example, a service provider 162 working through a system interface 164 on a carrier server 160, a campaign advisor 152 using a system interface 154 to work through a campaign manager 156 on a campaign server 150, and/or an advertiser 122 using a system interface 124 to work through a campaign client 126 on an advertiser workstation 120. Alternately, and preferably, this analysis may be automated so that certain metrics relating to campaign success are analyzed and compared against data that is collected relating to display of the unsolicited content. These metrics may, for example, be rules, and compliance with the rules may dictate whether or not the campaign has been successful, i.e., whether or not a campaign is complete.

If it is determined at Block 380 that the campaign is not complete, then it may be determined at Block 382 whether or not an update to the campaign is necessary. For example, the delivery manager 166 may be used either to continue an incomplete campaign without changes, or to update unsolicited content in an incomplete campaign. This decision process by the delivery manager 166 may be automated in that the decision on whether or not updated campaign may be made based on various metrics, i.e., rules. In some instances, this decision process by the delivery manager 166 may have a human in the loop, including, for example, a service provider 162 working through a system interface 164 on a carrier server 160, a campaign advisor 152 using a system interface 154 to work through a campaign manager 156 on a campaign server 150, and/or an advertiser 122 using a system interface 124 to work through a campaign client 126 on an advertiser workstation 120. Accordingly, if it is determined at Block 382 that the campaign is to be updated, then updating of the campaign may entail editing of the unsolicited content itself (Block 384) and/or editing the meta-data tags describing the unsolicited content (Block 386). The appropriate source databases may then be repopulated with the updated campaign content (Block 330). If, however, it is determined at Block 382 that no update to the campaign is necessary, then the system may continue to await a triggering event, such as receipt of a download request, at Block 350.

If it is determined at Block 380 that a campaign is complete, then unsolicited content for a campaign may be purged (Block 390) from the staging database 168 by the delivery manager 166. Alternatively, unsolicited content from a completed campaign may be archived in anticipation of the campaign being renewed at a later time (Block 395). If the campaign is renewed, then the process may be started again by recreating the purged ad 310, retagging the ad with meta-data 320, populating source databases with the ad 330, and restaging the ad for delivery 340.

### Scheduling

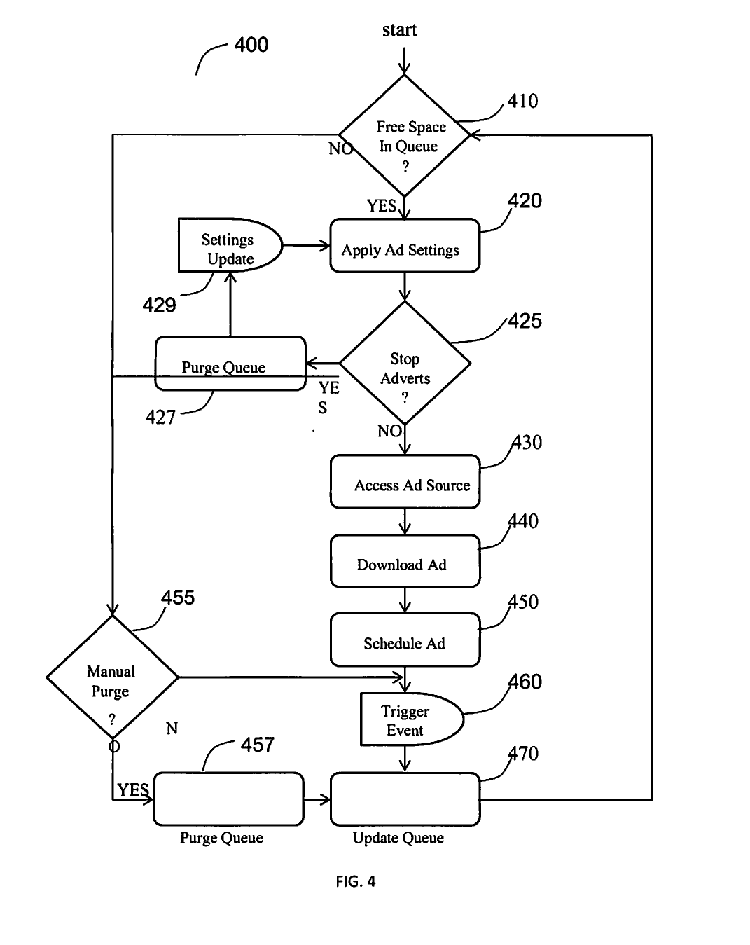

Referring now to flowchart 400 of FIG. 4, the operation of the scheduling function of the UCD system 100 will be discussed in greater detail. More specifically, the relationship between the carrier server 160, the mobile device 110, and the operational steps of scheduling unsolicited content for display will now be discussed. The following illustrative embodiment is included to provide clarity for one operational method that may be included within the scope of the present invention. A person of skill in the art will appreciate additional databases and operations that may be included within the UCD system 100 of the present invention, which are intended to be included herein and without limitation.

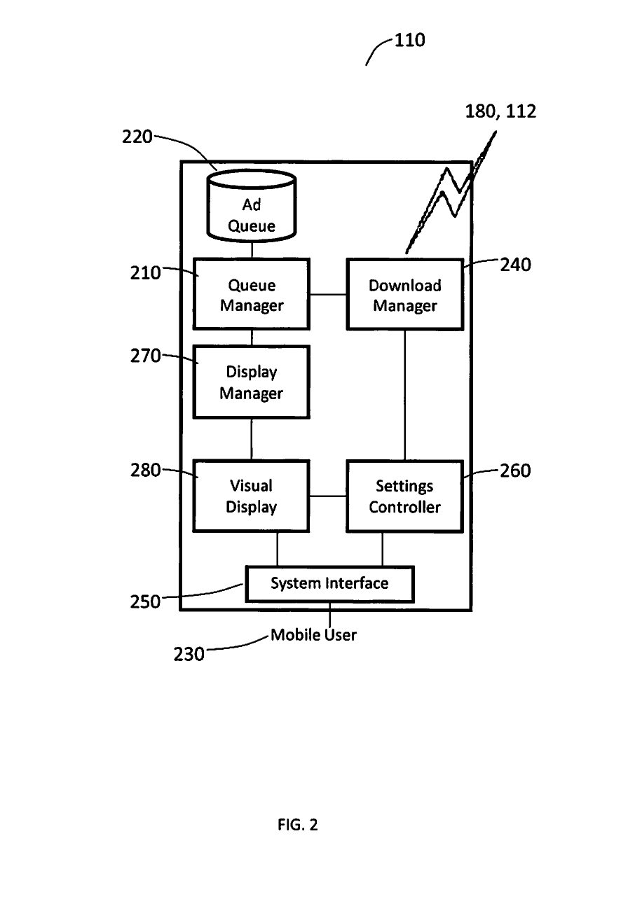

Referring now more specifically to FIG. 4 and with reference to the diagram of the mobile device illustrated in FIG. 2, from the start, the operation may begin at Block 410, where a queue manager 210 on a mobile device 110 may determine if free space is available in the ad queue 220 to cache unsolicited content. If the ad queue 220 is full, i.e., it is determined at Block 410 that there is no free space in the queue, it may be determined at Block 455 whether or not a mobile user 230 may desire to manually purge information to create space in the queue. If it is determined at Block 455 that the user desires to manually purge information, then the queue is purged at Block 457 and the queue is updated at Block 470. Thereafter, it is again determined at Block 410 whether or not free space exists in the queue. If it is determined at Block 455 that the user does not desire to engage in a manual purge, then the user may wait for some event (Block 460) to cause an update to the queue that clears space (Block 470) in the ad queue 230. For example, and without limitation, the playing of an ad on the mobile device 110 may be an event that causes the ad to be removed at Block 460 from the ad queue 220, thus freeing up space in the ad queue 230. In another example, and without limitation, recognition of the passing of an expiration date recorded as meta-data on an advert may be an event that triggers the removal of the expired ad at Block 460 from the ad queue 220, thus freeing up space in the ad queue 220.

Detection of free space in the ad queue 220 at Block 410 may cause the application of user-generated ad settings (Block 420) to govern the download of external unsolicited content to refill the ad queue 220. For example, and without limitation, at Block 425, it may be determined whether or not the mobile user 230 has configured ad settings on the mobile device 110 to stop any adverts from being downloaded. If it is determined at Block 425 that the mobile user has configured the ad settings on the mobile device 110 to stop adverts from being downloaded, the ad queue 220 may be purged of any unsolicited content at Block 427 and may remain empty until such time that the user changes ad settings, i.e., updates the ad settings at Block 429 to once again allow downloads. Thereafter, the ad settings are applied at Block 420.

If, however, it is determined at Block 425 that user-generated ad settings are configured to allow the download of external unsolicited content to fill available space in the ad queue 220, a download manager 240 may establish a communications link to access the appropriate ad source database at Block 430, as dictated by the delivery manager 166 on the carrier server 160 that provides mobile network service to the mobile device 110. For example, the ad source may be a staging database 168 on the carrier server 160, a campaign database 158 on a campaign server 150, and/or an advert database 144 on an advertiser host 140. Using the established communications link, the download manager 240 may download unsolicited content from an ad source (Block 440).

At Block 450, the ad that was downloaded at Block 440 may be scheduled for display. In other words, unsolicited content downloaded by the download manager 240 to the mobile device 110 may be added to the ad queue 220 in keeping with a retrieval algorithm that may be executed by the queue manager 210 to govern the retrieval of unsolicited content from that ad queue 220. For example, and without limitation, the retrieval algorithm may implement a first-in-first-out (FIFO) queue that presents unsolicited content for display in the order in which that content was downloaded to the mobile device 110. Alternatively, and without limitation, the retrieval algorithm may implement a priority queue that presents content based first on satisfaction of priority elements (e.g., play duration fit, related content match, geographic location match, browsing history match) and then as FIFO. A person of skill in the art will appreciate additional retrieval algorithms and operations that may be included within the UCD system 100 of the present invention, which are intended to be included herein and without limitation.

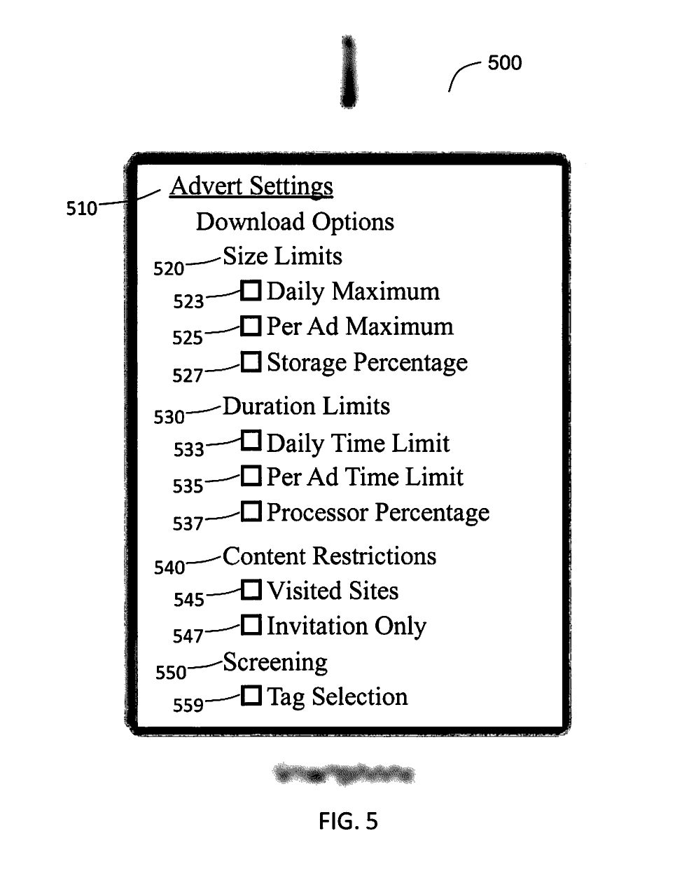

Referring now to FIG. 5, the exemplary graphical user interface 500 illustrates a model interface for configuring advert settings 510 on a mobile device 110. The graphical user interface 500 may include a plurality of fields which may allow for interaction by the mobile user 230.

For example, and presented without limitation, the mobile user 230 may active the Size Limits fields 520 to govern the maximum allowable digital file sizes for unsolicited content that may be downloaded to the mobile device 110 via the download manager 240. The mobile user 230 may use a system interface 250 to access a settings controller 260 to configure advert settings to set a download threshold for daily maximum total download size 523, a per ad maximum file size 525, and/or a maximum percentage of available storage 527 that may be enforced by the download manager 240.

Continuing from the preceding example, the mobile user 230 may activate the Duration Limits fields 530 to govern the maximum allowable play durations for unsolicited content that may be downloaded to the mobile device 110 via the download manager 240. The mobile user 230 may use a system interface 250 to access a settings controller 260 to configure advert settings to set a download threshold based on daily maximum total play time 533, a per ad maximum play time 535, and/or a maximum percentage of available processing time 537 that may be enforced by the download manager 240.

Continuing from the preceding example, the mobile user 230 may activate the Content Restrictions 540 and/or Screening fields 550 to govern assessment of unsolicited content for suitability to be downloaded to the mobile device 110 via the download manager 240. The mobile user 230 may use a system interface 250 to access a settings controller 260 to configure advert settings to set a download filter based on user visit history 545, explicit user approval 547, and/or user-defined acceptance criteria 559 that may be enforced by the download manager 240.

### Display

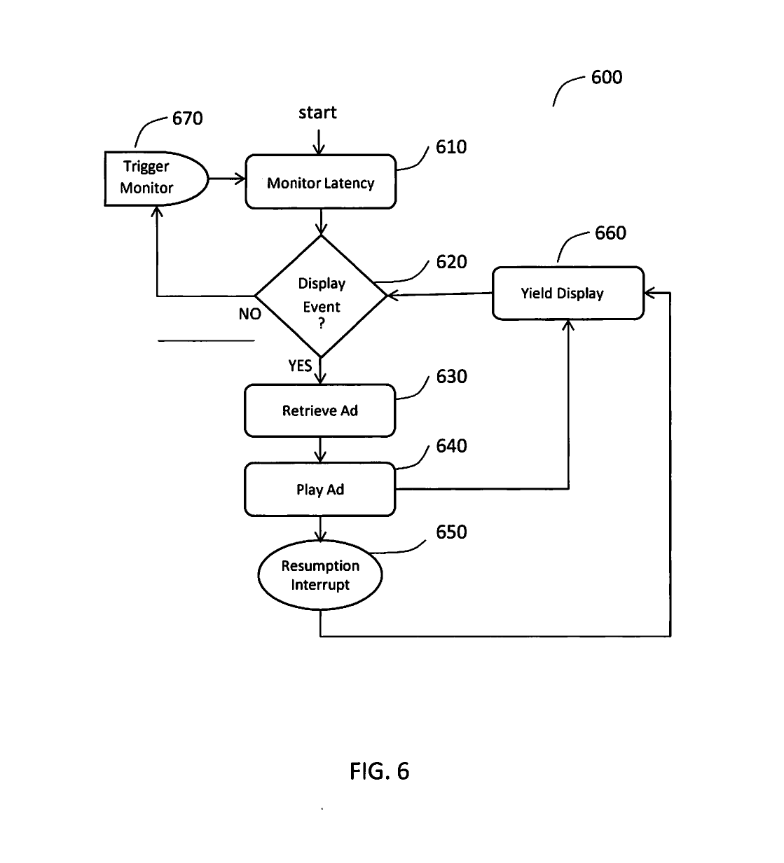

Referring now to flowchart 600 of FIG. 6, the operation of the display function of the UCD system 100 will be discussed in greater detail. More specifically, the relationship between the mobile device 110 and the operational steps of displaying unsolicited content will now be discussed. The following illustrative embodiment is included to provide clarity for one operational method that may be included within the scope of the present invention. A person of skill in the art will appreciate additional databases and operations that may be included within the UCD system 100 of the present invention, which are intended to be included herein and without limitation.

From the start, the operation of displaying unsolicited content on the mobile device 110 may begin by monitoring latency at Block 610. It is thereafter determined at Block 620 whether or not a display event has occurred. A display event (Block 620) may be any event that causes a delay, also called latency, in the operation of an application or program on the mobile device 110. More specifically, a display event (Block 620) may result in whitespace, or at least a portion of the electronic visual display 280 of the mobile device 110 being devoid of information to display, commonly referred to as being blank. Examples of display events (Block 620) include, without limitation, the mobile device 110 turning on, opening an application or program such as web browsing software, initiating a web page visit, initiating a download, or any other event that results in a delay pending completion of an operation of the mobile device 110.

If it is determined at Block 620 that a display event has not occurred, then the system may sleep until a trigger event (Block 670) causes a resumption of monitoring activity. If the trigger to resume monitoring occurs at Block 670, then the latency is again monitored at Block 610. If it is determined at Block 620 that a display event such as latency detection has occurred, then an ad may be retrieved at Block 630. This may be achieved by the display manager 270 on the mobile device 110 selecting unsolicited content from the ad queue 220 through the queue manager 210. Thereafter, the ad may be displayed at Block 640.

The ad that is displayed at block 640 may be displayed in the resulting whitespace on the electronic visual display 280. The unsolicited content displayed at Block 640 may comprise, for example and without limitation, one or more advertisements. The duration for which the one or more advertisements may be displayed on the electronic visual display 280 will vary according to the length of the delay caused by the display event. The longer the delay, the greater length of time the one or more advertisements may be displayed. If display of an ad (Block 640) completes before the period of delay ends, then control of the utilized space on the electronic visual display 280 is yielded at Block 660 to the application that caused the delay. Alternatively, the period of delay ends before the display of an ad (Block 640) completes, then at Block 650 the ad display may be terminated, i.e., the display may be interrupted, and normal operation of the display may be resumed. Specifically, the display may be yielded at Block 660 to allow resumption of display of information that is associated with the operation that caused the display event.

In an alternative embodiment, if the delay detected as a display event (Block 620) is greater than a threshold amount of time, for instance, ten seconds, a first advertisement (Block 630) may be displayed for the first ten seconds (Block 640), a second advertisement (Block 630) may be displayed for the second ten seconds (Block 640), etc., until the delay associated with the display event terminates at Block 650.

In an alternative embodiment, at Block 620 the length of a display event delay may be estimably determined. Determination of the length of the delay may depend on the nature of the task to be performed causing the delay as well as the capability of the mobile device 110 to expeditiously perform the task, thereby reducing the resulting delay. Once an estimation of the delay has been made, the display manager 270 on a mobile device 110 may select one or more advertisements (Block 630) from the unsolicited content stored on the ad queue 220 that require a delay of at least a certain length of time. For example, and without limitation, advertisements requiring a certain length of time to play may include videos, audio clips, and slideshows. This embodiment may permit the content to be displayed in its entirety (Block 640) without delaying the execution of the task (Block 650) causing the display event delay.

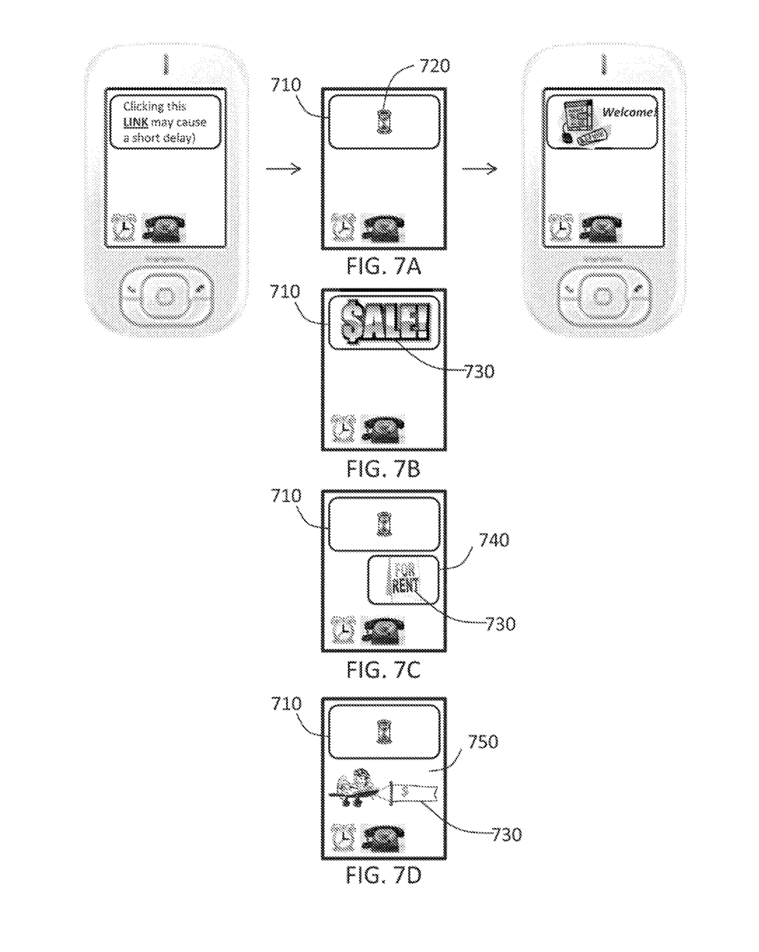

Referring now to FIGS. 7A, 7B, 7C and 7D, the exemplary graphical user interfaces 700 illustrate, without limitation, potential states of a visual display 280 on a mobile device 110 during a display event delay. More specifically, FIG. 7A shows an example of the current state of practice wherein a browser window 710 may present a wait cursor 720, such as an hourglass graphical icon, to visually inform a mobile user 230 of a display event delay.

Referring now more specifically to FIG. 7B, for example, and presented without limitation, the UCD system 100 may respond to a display event delay by displaying unsolicited content, such as an advertisement 730, instead of a wait cursor 720 within a latent browser window 710.

Referring now more specifically to FIG. 7C, in an alternative embodiment, the UCD system 100 may respond to a display event delay by displaying unsolicited content, such as an advertisement 730, within a newly activated browser window 740 that may be separate from the latent browser window 710 and may be presented in an otherwise unused area of a visual display 280.

Referring now more specifically to FIG. 7D, in an alternative embodiment, the UCD system 100 may respond to a display event delay by displaying unsolicited content, such as an advertisement 730, on a visible area of the screen real estate known as wallpaper 750 rather than within a latent browser window 710.

### Computing Device

Embodiments of the present invention are described herein in the context of a system of computers, servers, and software. Those of ordinary skill in the art will realize that the following embodiments of the present invention are only illustrative and are not intended to be limiting in any way. Other embodiments of the present invention will readily suggest themselves to such skilled persons having the benefit of this disclosure.

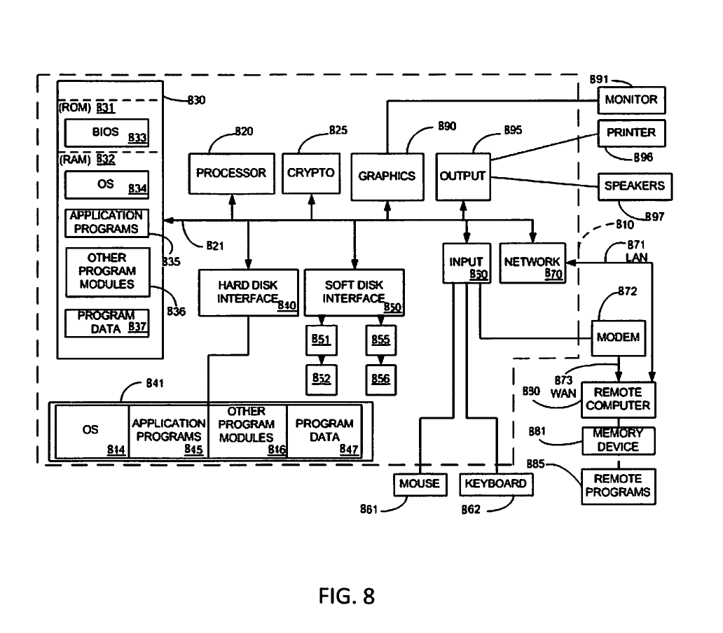

A skilled artisan will note that one or more of the aspects of the present invention may be performed on a computing device, including mobile devices. The skilled artisan will also note that a computing device may be understood to be any device having a processor, memory unit, input, and output. This may include, but is not intended to be limited to, cellular phones, smart phones, tablet personal computers (PCs), laptop computers, desktop computers, personal digital assistants (PDAs), etc. FIG. 8 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates an operating system (OS) 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 8, provide storage of computer readable instructions, data structures, program modules and other data for the computer 810. In FIG. 8, for example, hard disk drive 841 is illustrated as storing an OS 844, application programs 845, other program modules 846, and program data 847. Note that these components can either be the same as or different from OS 834, application programs 835, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

In accordance with embodiments of the present invention, the components, process steps, and/or data structures may be implemented using various types of operating systems, computing platforms, computer programs, and/or general purpose machines. In addition, after having the benefit of this disclosure, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The computer program, according to an embodiment of the present invention, is a computerized system that requires the performance of one or more steps to be performed on or in association with a computerized device, such as, but not limited to, a server, a computer (i.e., desktop computer, laptop computer, netbook, or any machine having a processor), a dumb terminal that provides an interface with a computer or server, a personal digital assistant, mobile communications device, such as an cell phone, smart phone, or other similar device that provides computer or quasi-computer functionality, a mobile reader, such as an electronic document viewer, which provides reader functionality that may be enabled, through either internal components or connecting to an external computer, server, or global communications network (such as the Internet), to take direction from or engage in processes which are then delivered to the mobile reader. It should be readily apparent to those of skill in the art, after reviewing the materials disclosed herein, that other types of devices, individually or in conjunction with an overarching architecture, associated with an internal or external system, may be utilized to provide the “computerized” environment necessary for the at least one process step to be carried out in a machine/system/digital environment. It should be noted that the method aspects of the present invention are preferably computer-implemented methods and, more particularly, at least one step is preferably carried out using a computerized device.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

1. A method for displaying unsolicited content on a mobile device, the method including the steps:
a step of providing one or more items of unsolicited content to the mobile device;
a step of the mobile device storing the one or more items of unsolicited content;
a step of detecting, in the mobile device, a latency delay event;
and
a step of displaying at least one of the one or more unsolicited items during the period of latency delay.

2. The method of claim 1 wherein the one or more unsolicited items are an ordered plurality of unsolicited items, and wherein the step of displaying the at least one of the one or more unsolicited items includes a step of displaying at least some of each of the ordered plurality of unsolicited items in ordered turn until the period of latency delay ends.

3. The method of claim 2 wherein each displayed unsolicited item is purged from the mobile device after display.

4. The method of claim 2 including the step of displaying each item of unsolicited material for a predetermined elapse of time.

5. The method of claim 2 wherein the mobile device displays each item of unsolicited material for a predetermined elapse of time.

6. The method of claim 1 for use where the mobile device comprises a display screen, the method including the step of providing display of unsolicited material on temporarily unused areas of the display screen including at least one of: a whitespace area of the display screen otherwise used for general content display and an area of the display screen usually used for display of wallpaper.

7. The method of claim 1 including the step tailoring the size of an unsolicited content file in accordance with limitations of the mobile device.

8. The method of claim 1 wherein the mobile device comprises means for locating the position of the mobile device, including the step of the mobile device responding to the located position of the mobile device to select, for display, one or more unsolicited items each relevant to the located position.

9. The method of claim 1 including the steps of: a user of the mobile device providing indication to a provider of unsolicited content whether to provide unsolicited content; and a step of the provider responding to the indication of the user.

10. The method of claim 1 wherein the mobile device comprises:
a location detector activated to locate the position of the mobile device and providing indication thereof,
an unselected content filter, in receipt of the indication of the location detector and responding thereto to restrict display to items relating to the indicated location.

11. The method of claim 1 wherein the unsolicited material includes one or more advertisements.

12. A system for displaying unsolicited content on a mobile device, the system comprising:
one or more servers providing one or more items of unsolicited content to the mobile device;
storage means in the mobile device storing the one or more items of unsolicited content;
a latency delay event detector in the mobile device;
and
display means displaying at least one of the one or more unsolicited items during the period of latency delay.

13. The system of claim 12 wherein:
the one or more servers provide unsolicited items as an ordered plurality of unsolicited items,
and wherein
the mobile device displays at least some of each of the ordered plurality of unsolicited items in ordered turn until the period of latency delay ends.

14. The system of claim 13 wherein each displayed unsolicited item is purged from the mobile device after display.

15. The system of claim 12 wherein:
the mobile device comprises a display screen;
and
the mobile device displays unsolicited material on temporarily unused areas of the display screen including at least one of: a whitespace area of the display screen otherwise used for general content display and an area of the display screen usually used for display of wallpaper.

16. The system of claim 12 wherein the one or more servers tailor the size of an unsolicited content file in accordance with limitations of the mobile device.

17. The system of claim 12 wherein:
the mobile device comprises means for providing indication to a provider of unsolicited content whether to provide unsolicited content;
and
the one or more servers respond to the indication of the mobile device.

18. The system of claim 12 wherein the unsolicited material includes one or more advertisements.

19. An unsolicited advertisement adapted for display using a method for displaying one or more unsolicited advertisement on a mobile device, the method including the steps:
a step of providing one or more unsolicited advertisements to the mobile device;
a step of the mobile device storing the one or more unsolicited advertisements;
a step of detecting, in the mobile device, a latency delay event;
and
a step of displaying at least one of the one or more unsolicited advertisements during the period of latency delay.
